(19) United States
(12) Patent Application Publication
(10) Pub. No.: US 2025/0088575 A1
(43) Pub. Date: Mar. 13, 2025

(54) PROTOCOL ADAPTER ARRANGEMENT WITH PIN SWITCHING FOR DoIP

(71) Applicant: Dearborn Group, Inc., Farmington Hills, MI (US)

(72) Inventors: Mark P. Zachos, West Bloomfield, MI (US); Robin BLANTON, Grosse Ile, MI (US)

(73) Assignee: Dearborn Group, Inc., Farmington Hills, MI (US)

(21) Appl. No.: 18/830,894

(22) Filed: Sep. 11, 2024

Related U.S. Application Data
(60) Provisional application No. 63/581,732, filed on Sep. 11, 2023.

(51) Int. Cl. H04L 69/08; G07C 5/00; H04L 12/40

(52) U.S. Cl. CPC H04L 69/08; G07C 5/008; H04L 12/40169; H04L 2012/40215; H04L 2012/40273

(57) ABSTRACT

A protocol adapter for providing communication between a vehicle network and an external client in one or more of a plurality of protocols. The protocol adapter includes a plurality of pins connected to a pin array on a vehicle communications port, to allow the protocol adaptor to communication with a vehicle network. The protocol adapter includes both a plurality of CAN communication paths and an ethernet communication path providing DoIP communication through the vehicle communications port.

### FIELD OF THE INVENTION

The present invention relates to in-vehicle and industrial communications networks for diagnostics, analysis and monitoring.

### BACKGROUND OF THE INVENTION

A typical protocol adapter is connected to a motor vehicle such as a car, sport-utility vehicle, or the like, and communicates with the vehicle using a specialized communications protocols called controller area network (CAN) protocols that communicate over a pin array (e.g., J1962 connector). Some vehicles have a multiplex communication network which utilizes more than one communications protocol, and it is necessary for the protocol adapter to also be able to communicate in more than one network protocol, as well as translate information from the vehicle network to an external client. Multiplex communication networks are used in both automotive and industrial automation application. However, there is a need to access, monitor, control and modify/update any and all functions or capabilities of another device utilizing such communication networks.

One particular multiplex communication network includes both CAN protocol and diagnostics over Internet protocol (referred to as DoIP), the latter utilizes ethernet communication. Utilizing these complex vehicle systems creates a need to provide greater data transfer over a pin array (e.g., J1962 connector). Using both ethernet and CAN over the same pin array presents a challenge and requires some form of pin switching circuitry to properly route the pin signals to the physical layer components for the selected interface (CAN or ethernet). It is possible to accomplish this using analog switch devices but these devices are not suitable for switching of an isolated ethernet link because ethernet uses transformers on each end of each pair in order to isolate the cable. There is a need to provide a protocol adapter arrangement with improved circuitry that will enable both CAN and ethernet communication over the same pin array, without using separate cables or analog switches.

### SUMMARY OF THE INVENTION

The present invention is directed to a protocol adapter for providing communication between a vehicle network and an external client in one or more of a plurality of protocols. The protocol adapter includes a plurality of pins connected to a pin array on a vehicle communications port, to allow the protocol adaptor to communication with a vehicle network. The protocol adapter has both a plurality of CAN communication paths and an ethernet communication path providing DoIP communication through the vehicle communications port. The protocol adapter further includes a wireless communications bus in the protocol adaptor that allows communication between the protocol adaptor and an external client, in order to facilitate communication between the vehicle network and the external client. The protocol adapter can also have a pass through mode that allow for communications to bypass the protocol adapter and communicate with the external client without any filtering.

The protocol adapter further includes a memory device in electrical communication with the external client, such that said memory device is operable to receive data from a vehicle network operating in said vehicle network protocol during the initial boot up of said protocol adapter and said external client.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an overview system diagram of the protocol adapter.

FIG. 2A is a portion of a circuit schematic diagram of a pin multiplexing switch circuit of the protocol adapter.

FIG. 2B is a portion of a circuit schematic diagram of a pin multiplexing switch circuit.

FIG. 2C is a portion of a circuit schematic diagram of a pin multiplexing switch circuit.

### DETAILED DESCRIPTION OF THE PREFERRED EMBODIMENTS

The following description of the preferred embodiment is merely exemplary in nature and is in no way intended to limit the invention, its application, or uses.

An opto FET switch as used herein is defined to be an optical-coupled metal oxide semiconductor field effect transistor (MOSFET) switch that is a solid state relay that uses a light-emitting diode (LED) as input and MOSFETs as the contact point.

Controller Area Network (CAN) protocol is referring to a serial communication protocol that allows devices, such as a vehicle electronic control unit (ECU), also referred to herein as a vehicle network and an external computer to exchange data in a reliable and efficient way.

A CAN path is defined a pathway through a control circuit for allowing the passage of communications between the ECU and external computer through a pin physically coupled to a vehicle communications port.

An ethernet communication path is defined herein as a pathway through a control circuit for allowing the passage of communications between the ECU and an external computer through a pin physically coupled to a vehicle communications port.

External clients as used herein is defined as applications and computers accessing the protocol adapter via TCP/IP networking. While two external clients are described herein, it is within the scope of this invention for a greater or lesser number of external clients to be present.

Operating system transmission control protocol/Internet protocol interface (O/S TCP/IP interface) as used herein is defined as a set of communication protocols that allow data to be transferred and communicated across networks including the Internet.

Serial peripheral hardware interconnect (SPI interface) as used herein is defined as hardware operating a communication protocol used to transfer data between microcontrollers, sensors and other peripheral devices, including control of CAN protocol data and ethernet communications described below to a vehicle network. Also included is PIN MUX Interface which includes an on board diagnostic 2 interface (OBD2) having pin multiplexing software (PINMUX) that allows for a single pin or pins to be used for multiple functions, in this case switching between ethernet and CAN protocol communication paths between external devices and a vehicle network.

The term device driver as used herein is a type of software that acts as a translator between a computer operating system and its hardware devices. It allows the operating system to communicate with devices like external computers, SPI and pinmux interface hardware and vehicle networks.

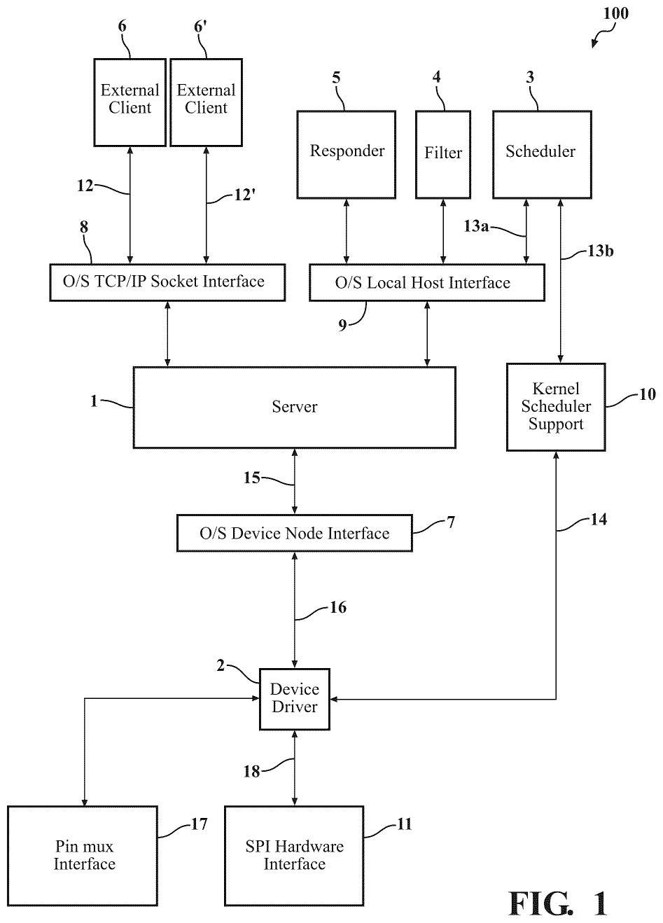

Referring now to FIG. 1 is an overview system diagram of a protocol adapter 100. The general software architecture of the components of the device software system is provided by a server program that handles communication between external clients 6, 6′ through an O/S TCP/IP interface 8, on lines 12, 12′ and other parts of the protocol adapter software include a scheduler 3, a filter 4 and a responder 5 communicate through an operating system (O/S) local host interface 9. The external clients' 6, 6′ are external host computers or other devices that need to communicate with the vehicle network. It is within the scope of this invention for O/S TCP/IP interface 8 to be a wireless communications bus where lines 12, 12′ are wireless communication channels and not physical connections.

The scheduler 3 is a plug-in software module message scheduler 3 that provides a user-controllable multiplex network message scheduler. Lists of messages, sub-lists, iteration counts, and iteration periods are specified by client applications. The scheduler 3 tracks multiple schedules and notifies client programs via events when the schedules are complete. Message scheduling is performed by means of a real-time hardware clock and associated services provided by the operating system via the O/S local host interface 9 on scheduler line 13a. The scheduler 3 is also connected to a kernel scheduler support 10 on scheduler line 13b. The kernel scheduler support 10 is connected to a device driver 2 on a kernel scheduler support (KSS) line 14. The kernel scheduler support is a device driver that provides kernel-level scheduling services used by the scheduler 3. The scheduler 3 is a client program that runs in the operating systems user space, while kernel scheduler support 10 is a device driver that runs in kernel space.

The filter 4 controls filtering of received multiplex network messages. The filter 4 allows individual client applications to choose the nature of the messages they receive based on a filter specification for each multiplex network channel that includes AND, OR, magnitude comparison, and bit mask/match operations. The responder 5 provides user-definable message gatewaying functionality. The message responder 5 allows any arbitrary CP frame to be sent on receipt of any other arbitrary CP frame. Received frame matching is determined based on a user-defined filter definition that includes AND, OR, magnitude comparison, and bit mask/match operations.

The O/S local host interface 9 is a loopback TCP/IP interface that functions to allow onboard client software to communicate with the server.

The server 1 acts primarily as a message router, routing GC Protocol frames between source entities and a destination. The server 1 communicates with an operating system (O/S) device node interface 7 over a line 15, which then communicates with the device driver 2 over line 16. The device driver 2 receives communication from O/S device node interface 7 and k kernel scheduler support 10 and then communications over driver line 18 with a SPI interface hardware 13 that is the interface between the external devices 6,6′ and a vehicle network. The server 1 also further includes a memory device in electrical communication with the external client 6, 6′, such that the memory device is operable to receive data from a vehicle network operating in the vehicle network protocol during the initial boot up of the protocol adapter 100 and the external client 6, 6′.

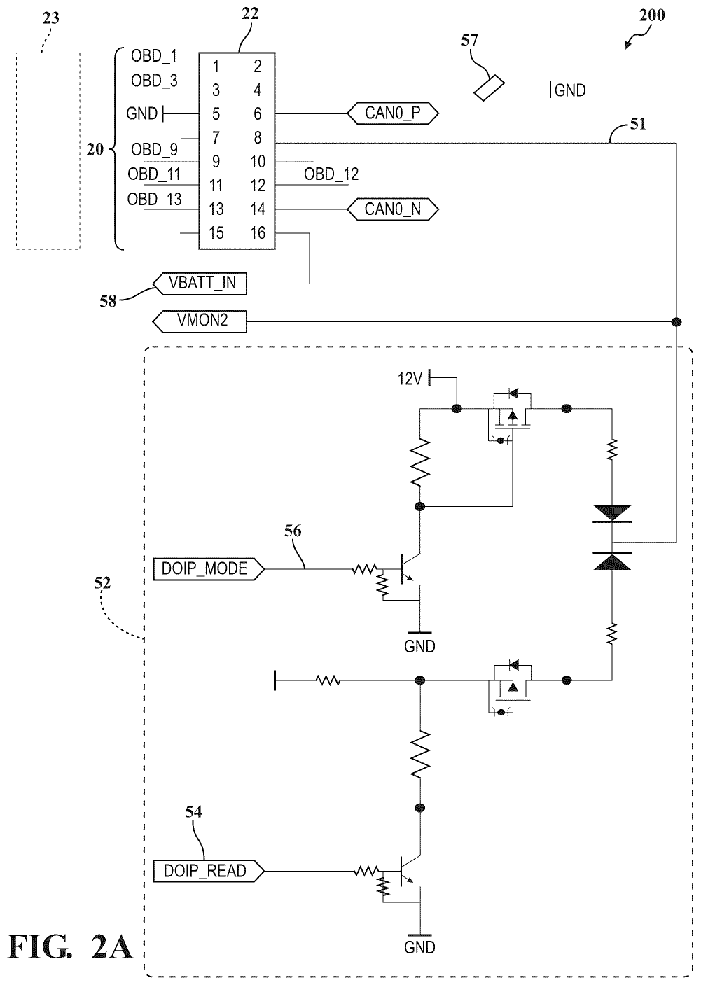

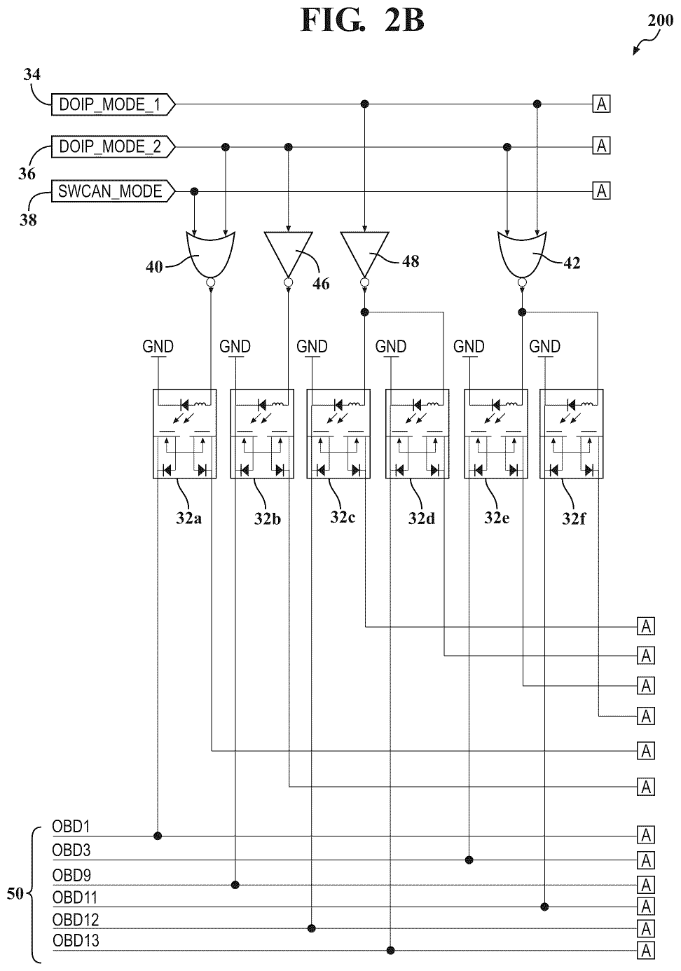

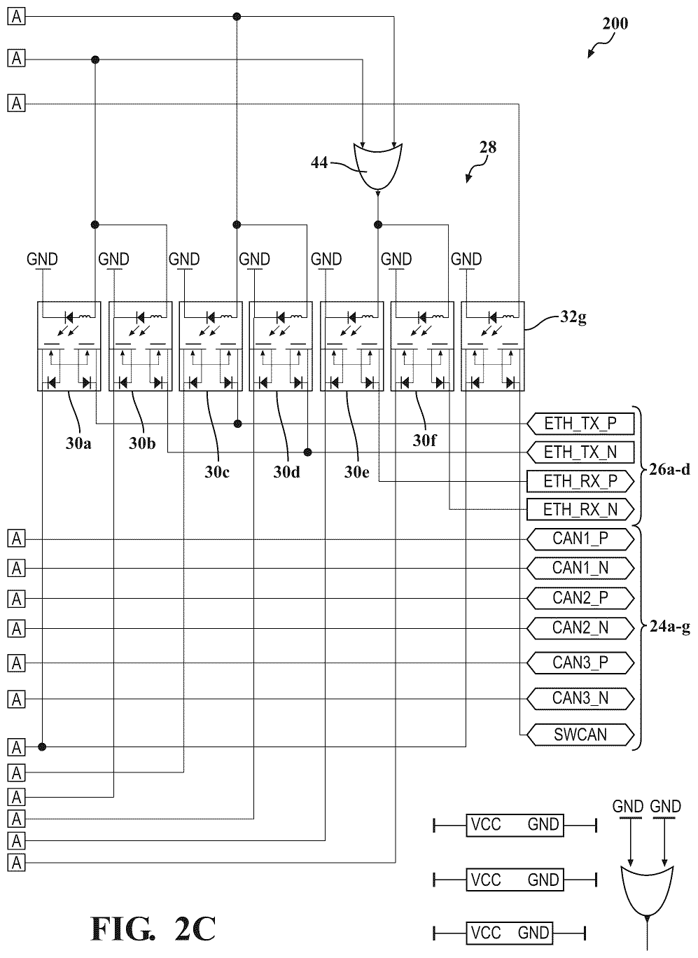

FIG. 1 also shows a PIN MUX Interface 17, which includes an on board diagnostic 2 interface (OBD2) having pin multiplexing software (PINMUX) that allows for a single pin or pins to be used for multiple functions, such as switching between ethernet and CAN protocol communication paths between external devices and a vehicle network. Further included in the PIN MUX Interface 17 is DoIP detection/activation software that selects between CAN and ethernet pin configurations, which is shown in the circuit schematic of FIG. 2.

Referring now to FIGS. 1, 2A, 2B, 2C, the protocol adapter 100 provides communication between a vehicle electronic control unit using pins 20 on an OBD2 interface 22 and the external clients 6, 6′ which include an external client. The pins 20 of the protocol adapter include four pins that are for ethernet communication and the ethernet communication path has four wires with each one of the four wires connected to one of the four pins. The pins 20 are also used for both the CAN communication path and ethernet communication path.

The pins 20 of the OBD2 interface 22 are shown as numbering a total of sixteen pins, however it is within the scope of this invention for there to be a greater or lesser number of pins depending on the type of connect used on the vehicle. The pins 20 are connectable to a pin array on a vehicle communications port 23 to allow the protocol adaptor 100 to communication with a vehicle network in a plurality of protocols. In one aspect of the invention the pin array conforms to a J1962 connector.

The protocol adapter 100 includes a switching circuit 200, shown in FIGS. 2A, 2B, 2C. The switching circuit 200 includes control area network (CAN) communication paths 24a, 24b, 24c, 24d, 24e, 24f, 24g totaling seven, which can include a greater or lesser number depending on the particular application. The CAN communication paths 24a, 24b, 24c, 24d, 24e, 24f are each schematic net names. _As shown in FIGS. 2A, 2B, 2C show P and _N are notations indicating differential pair signals. In this case, CANx_P=CAN High signal; CANx_N=CAN Low signal Also shown are ethernet communication paths 26a, 26b, 26c, 26d totaling four, which can also be present in a greater or lesser number depending on the application. The ethernet communication paths 26a, 26b, 26c, 26d shown in FIGS. 2A, 2B, 2C show differential pair net names. One pair for ethernet receive (RX); one pair for ethernet transmit (TX). Each CAN communication paths 24a, 24b, 24c, 24d, 24e, 24f, 24g selectively provide CAN protocol communication though the pins 20 to the vehicle communications port 23. Each ethernet communication path 26a, 26b, 26c, 26d selectively provides diagnostics over internet protocol (DoIP) communication through the at least one of the pins 20 to the vehicle communications port 23.

The selection of which of the various CAN communication paths 24a, 24b, 24c, 24d, 24e, 24f, 24g and ethernet communication paths 26a, 26b, 26c, 26d is accomplished using a detection circuit 28. The detection circuit 28 includes a first group of six optical-coupled MOSFET switches 30a-f connected to the ethernet communication paths 26a, 26b, 26c, 26d which connect either CAN or Ethernet signals to the OBD2 connector pins 20, depending on the software select pin mux configuration. As shown there are 3 mutually exclusive pinmux modes including CAN, DOIP 1 and DOIP 2. These modes are selected base on a first mode input 34 (on= DOIP_MODE_1), a second input mode (on= DOIP_MODE_2) and when first input mode 34 and second input mode 16 are off, a third input mode 38 (SWCAN_MODE) is active. Third input mode 38 further allows switching one pin (OBD2 pin 1) over to single-wire CAN mode (instead of normal 2-wire CAN mode) when the pinmux mode is CAN.

Ethernet communication paths 26a. 26b are ETH_TX_P and ETH_TX_N paths are transmission paths each connected to two optical-coupled MOSFET switches 30a-d, while ethernet communication paths 26c, 26d are ETH_RX_P and ETH_RX_N paths are receiving paths each connected to just one optical-coupled MOSFET switches 30e, 30f. The detection circuit 28 also includes a second group of optical-coupled MOSFET switches 32A-g each connected to one of the CAN communication paths 24a, 24b, 24c, 24d, 24e, 24f, 24g. The optical-coupled MOSFET switches 30a-f and 32A-g allow the protocol adapter 100 to isolate and switch between the various CAN communication paths 24a, 24b, 24c, 24d, 24e, 24f, 24g and ethernet communication paths 26a, 26b, 26c, 26d allowing for the wireless communications bus 8 in the protocol adaptor 10 to allow communications between the external client 6, 6′ and the vehicle network. The CAN communication paths 24a, 24b, 24c, 24d, 24e, 24f, 24g are able to communicate using a plurality of control area network (CAN) protocols that include one selected from the group consisting of CAN, CAN FD, Ethernet.

The detection circuit 28 is controlled by three mode selection inputs, which include the first mode input 34 (DOIP_MODE_1), the second mode input 36 (DOIP_MODE_2), and the third mode input 38 (SWCAN_MODE), in combination with three NOR gates 40, 42, 44 and two digital logic inverters 46, 48 (i.e., NOT gates). In the detection circuit 28 the inverters, OR gates and NOR gates form a combinatorial logic circuit that produces control signals for all of the opto-FETs 30a-f and 32A-g based on the three mode input signals (first mode input 34, second mode input 36, third mode input 38).

The three mode selection inputs control which pins on the OBD2 interface 22 are utilized. As shown there are three mode selection inputs, where the first mode input 34 and the second mode input 36 are two DoIP variants and third mode input 38 is a default where all the pins are used for CAN lines. The first input mode 34 designates pins 3, 11 of the OBD2 interface 22 as the receive lines and pins 12 and 13 are transmit lines. The second mode input 36 designates pins 1, 9 on the OBD2 interface 22 as the receive lines and pins 12 and 13 are transmit lines. When operating in the third mode input 38 all pins of the OBD2 interface 22 are used for CAN lines. The following table indicates which pins of the OBD2 interface 22 are used during each of the three mode selection inputs.

| | SWCA_MODE (CAN mode) | | | DOIP_MODE_1 | DOIP_MODE_2 |
|---|---|---|---|---|---|
| OBD2 Pin | SocketCAN | GCP Channel | Function | Ethernet Pin | Ethernet Pin |
| 1 | CAN4 | 4 | CAN-H | | |
| 2 | | | | | |
| 3 | CAN3 | 3 | CAN-H | RX+ | |
| 4 Ground | | | | | |
| 5 Ground | | | | | |
| 6 | CAN1 | 1 | CAN-H | | |
| 7 N/C | | | | | |
| 8 | | | VMON2 | Activation | Activation |
| 9 | CAN4 | 4 | CAN-L | | RX− |
| 10 N/C | | | | | |
| 11 | CAN3 | 3 | CAN-L | RX− | |
| 12 | CAN2 | 2 | CAN-H | TX+ | TX+ |
| 13 | CAN2 | 2 | CAN-L | TX− | TX− |
| 14 | CAN1 | 1 | CAN-L | | |
| 15 N/C | | | | | |
| 16 VBATT | | | | | |

As shown in the Table above there are two DOIP modes because this is what the Diagnostics over IP standard (ISO13400) defines. The two DOIP modes route the ethernet signals to different sets of pins on the OBD2 connector; pin assignment is not standardized across vehicle manufacturers. The mode selection inputs provide a plurality of modes including two diagnostics over internet protocol (DoIP) modes and a CAN mode. One pin of the protocol adapter is connected to a detection circuit for optional auto-detection of the correct mode for the connected vehicle or ECU.

Shown in FIG. 2B there are several named network connections 50, schematically shown, which connect to the named network connection shown on the OBD2 interface 22. As explained above, the detection circuit 28 controls which connections are turned off and on depending on the mode that is selected.

As shown in FIG. 2A a DoIP switch circuit 52 is connected to a DoIP activation line 51 (i.e., pin 8) on the OBD2 interface 22 is taken from the output of the combinatorial gate circuit electrically connected to the same named net at pin 7 of NOR gate 44. This signal is high/active whenever one of the two DOIP modes (i.e., first mode input 34 or second mode input 36) are selected. The DoIP switch circuit 52 allows one of two voltages to be switched onto the DoIP activation line 51. DoIP Input 54 switches a low pull-up voltage (3.3V) onto the DoIP activation line 51. This is enough to read any vehicle-side resistors (by reading the resulting analog voltage on signal VMON2) WITHOUT exceeding the vehicle's activation voltage. Once this activation resistance is read, software can then activate either first mode input 24 or second mode input 34 as appropriate. Activating either mode causes DoIP activation line 51 to become active, when this happens the DoIP switch circuit 52 connects the DoIP activation line 51 to a higher (12V) pull-up voltage, signaling DOIP activation to the vehicle. This behavior is based on the functionality outlined in International Organization for Standardization, IS013400-2:2019, the entire contents of which are hereby incorporated by reference. Also connected to the OBD2 interface 22 is a ferrite bead 56 that provide electromagnetic interference protection.

FIG. 2A also includes a power supply 58 that provides power input from the vehicle that powers the entire adapter.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A protocol adapter for providing communication between a vehicle electronic control unit and an external client comprising:
a protocol adapter having a at least one pin connected to a pin array on a vehicle communications port to allow the protocol adaptor to communication with a vehicle network in a plurality of protocols, wherein the protocol adapter includes both at least one control area network (CAN) communication path and at least one ethernet communication path, wherein the at least one ethernet communication path selectively provides diagnostics over internet protocol (DoIP) communication through the at least one pin to the vehicle communications port, wherein the at least one pin is connected to both the at least one CAN communication path and the at least one ethernet communication path;
a switching circuit that includes a plurality of optical-coupled MOSFET switches for isolating and switching the protocol adapter between the at least one CAN communication path and the at least one ethernet communication path over the at least one pin of the protocol adapter;
a wireless communications bus in the protocol adaptor that allows communication between the protocol adaptor and an external client.

2. The protocol adapter of claim 1, wherein the pin array conforms to a J1962 connector.

3. The protocol adapter of claim 1 further comprising a memory device in electrical communication with the external client, such that said memory device is operable to receive data from a vehicle network operating in said vehicle network protocol during the initial boot up of said protocol adapter and said external client.

4. The protocol adapter of claim 1 wherein the at least one pin of the protocol adapter is connected to a detection circuit for determining at least one mode of the DoIP communication being transmitted.

5. The protocol adapter of claim 1, wherein the at least one pin of the protocol adapter is four pins that are for ethernet communication and the ethernet communication path has four wires with each one of the four wires connected to one of the four pins.

6. The protocol adapter of claim 1, wherein said at least one CAN communication path communicates using a plurality of control area network (CAN) protocols that include one selected from the group consisting of CAN, control area network flexible data rate (CAN FD), and Ethernet.

7. The protocol adapter of claim 1 further comprising a plurality of mode selection inputs that command the plurality of optical-coupled MOSFET switches to operate in one of a plurality of modes.

8. The protocol adapter of claim 7, wherein the plurality of modes include one or more diagnostics over internet protocol (DoIP) modes on the at least one ethernet communication path and a CAN mode.

9. A protocol adapter for providing communication between a vehicle electronic control unit and an external client comprising:
a protocol adapter having a at least four pins at are part of an on board diagnostic (OBD2) interface that is connected to pin array on a vehicle communications port to allow the protocol adaptor to communication with a vehicle network in a plurality of protocols, wherein the protocol adapter includes both at least one control area network (CAN) communication path and an ethernet communication path that is a four wire ethernet connection, wherein the ethernet communication path selectively provides diagnostics over internet protocol (DoIP) communication through the OBD2 interface to the vehicle communications port, wherein the at least four pins are connected to both the at least one CAN communication path and the ethernet communication path;
a switching circuit that includes a plurality of optical-coupled MOSFET switches for isolating and switching the protocol adapter between the at least one CAN communication path and the ethernet communication path over the at least four pins of the OBD2 interface;
a wireless communications bus in the protocol adaptor that allows communication between the protocol adaptor and an external client.

10. The protocol adapter of claim 9, wherein the pin array conforms to a J1962 connector.

11. The protocol adapter of claim 9, further comprising a memory device in electrical communication with the external client, such that said memory device is operable to receive data from a vehicle network operating in said vehicle network protocol during the initial boot up of said protocol adapter and said external client.

12. The protocol adapter of claim 9, wherein the at least one pin of the protocol adapter is connected to a detection circuit for determining at least one mode the DoIP communication being transmitted.

13. The protocol adapter of claim 9, wherein each one of the four wires of the ethernet communication path are connected to one of the at least four pins.

14. The protocol adapter of claim 9, wherein said at least one CAN communication path communicates using a plurality of control area network (CAN) protocols that include one selected from the group consisting of CAN, control area network flexible data rate (CAN FD), and Ethernet.

15. The protocol adapter of claim 9 further comprising a plurality of mode selection inputs that command the plurality of optical-coupled MOSFET switches to operate in one of a plurality of modes.

16. The protocol adapter of claim 15, wherein the plurality of modes include one or more diagnostics over internet protocol (DoIP) modes on the ethernet communication path and a CAN mode.
